(19) United States
(12) Patent Application Publication
(10) Pub. No.: US 2016/0080940 A1
(43) Pub. Date: Mar. 17, 2016

(54) Method, Apparatus, and System for Configuring Wireless Device

(71) Applicant: Huawei Device Co., Ltd., Shenzhen (CN)

(72) Inventors: Gaokun Pang, Shenzhen (CN); Zhiming Ding, Shenzhen (CN)

(21) Appl. No.: 14/936,827

(22) Filed: Nov. 10, 2015

Related U.S. Application Data
(63) Continuation of application No. PCT/CN2014/077203, filed on May 12, 2014.

(30) Foreign Application Priority Data
May 10, 2013 (CN) 201310172722.0
Aug. 2, 2013 (CN) 201310334762.0

(51) Int. Cl. H04W 12/06; H04W 12/04; H04W 76/02; H04W 4/00

(52) U.S. Cl. CPC H04W 12/06; H04W 4/008; H04W 12/04; H04W 76/02; H04W 84/12

(57) ABSTRACT

A method for configuring a wireless device includes acquiring, by a third device, information about a first device, sharing a first key with the first device, and sending a first trigger message to the first device, where the first trigger message includes information about the third device; and acquiring, by the third device, information about a second device, sharing a second key with the second device, and sending a second trigger message to the second device, where the second trigger message includes the information about the third device and the information about the first device, such that the second device negotiates, according to the information about the third device and the information about the first device and based on authentication of the third device, with the first device to generate a third key, and establishes a connection between the first device and the second device using the third key.

### CROSS-REFERENCE

This application is a continuation of International Application No. PCT/CN2014/077203, filed on May 12, 2014, which claims priority to Chinese Patent Application No. 201310172722.0, filed on May 10, 2013 and Chinese Patent Application No. 201310334762.0, filed on Aug. 2, 2013, all of which are hereby incorporated by reference in their entireties.

### TECHNICAL FIELD

Embodiments of the present disclosure relate to the field of network technologies, and in particular, to a method, an apparatus, and a system for configuring a wireless device.

### BACKGROUND

To resolve puzzles of a user at the time of configuring and using a wireless network, the Wireless Fidelity (WiFi) Alliance proposes the Wireless Fidelity Protected Setup (WPS) specification, in order to simplify a process in which a wireless device joins, using an access point (AP), a wireless local area network (WLAN) set by the AP. In WiFi peer-to-peer (P2P) communication, end-to-end direct discovery between wireless devices may be implemented using a WiFi function.

In a WPS authentication procedure, a wireless device may use a personal identification number (PIN) method, a push button control (PBC) method, a near field communication (NFC) method, or short-range WiFi communication to join the WLAN using the AP. In the WiFi P2P communication, authentication between wireless devices also uses the WPS authentication procedure, that is, a connection between the wireless devices may be established using the PIN method, the PBC method, the NFC method, or the short-range WiFi communication.

However, in the PIN method or the PBC method, a wireless device needs to have an input device and a display device to input and display a key; in the NFC method, a wireless device that is to join the WLAN needs to support an NFC function, and both of two wireless devices that are to establish WiFi P2P communication need to support the NFC function; in short-range WiFi communication, a wireless device that is to join the WLAN needs to support a short-range WiFi communication function, and both of two wireless devices that are to establish WiFi P2P communication need to support the short-range WiFi communication function.

When neither of two wireless devices that are to establish a WiFi P2P connection has an input device or a display device, and authentication configuration methods supported by the two wireless devices are different, the P2P connection cannot be implemented using the WPS authentication procedure; when a wireless device that is to join the WLAN does not have an input device or a display device, and does not support the NFC function or the short-range WiFi communication function, the wireless device cannot join the WLAN set by the AP.

Therefore, the existing WPS authentication procedure has a relatively high requirement on a wireless device, and has an application limitation.

### SUMMARY

The present disclosure provides a method, an apparatus, and a system for configuring a wireless device, which are used to resolve a problem that an existing WPS authentication procedure has a relatively high requirement on a wireless device and an application limitation exists.

According to a first aspect, a method for configuring a wireless device is provided, including acquiring, by a third device, information about a first device, sharing a first key with the first device, and sending a first trigger message to the first device, where the first trigger message includes information about the third device; and acquiring, by the third device, information about a second device, sharing a second key with the second device, and sending a second trigger message to the second device, where the second trigger message includes the information about the third device and the information about the first device, such that the second device negotiates, according to the information about the third device and the information about the first device and based on authentication of the third device, with the first device to generate a third key, and establishes a connection with the first device using the third key.

Based on the first aspect, in a first possible implementation manner, the acquiring, by the third device, the information about the first/second device includes acquiring, by the third device and by scanning a two-dimensional code of the first/second device, the information that is about the first/second device and corresponding to the two-dimensional code; or acquiring, by the third device, the information about the first/second device in an NFC manner; or acquiring, by the third device, the information about the first/second device in a short-range WiFi communication manner.

Based on the first possible implementation manner of the first aspect, in a second possible implementation manner, the sharing the first/second key with the first/second device includes negotiating, by the third device, with the first/second device to generate the first/second key; or sending, by the third device, the first/second key to the first/second device in the NFC/short-range WiFi communication manner, or receiving the first/second key sent by the first/second device; or acquiring, by the third device and by scanning the two-dimensional code of the first/second device, the first/second key set by the first/second device.

Based on the first aspect or the first or second possible implementation manner of the first aspect, in a third possible implementation manner, the third device is a trusted third-party wireless device, includes one or more function modules or software programs, and is configured to implement one or more of the following: a man-machine interface function, a two-dimensional code identification function, a PIN function, a PBC function, an NFC function, and a short-range WiFi communication function. The man-machine interface includes an input module or a display module, or a combination of the two.

Based on the first possible implementation manner of the first aspect, in a fourth possible implementation manner, the information about the first device includes a working channel of the first device, and the information about the second device includes a working channel of the second device; and after the acquiring, by a third device, information about a first device, or the acquiring, by the third device, information about a second device, the method includes adjusting, by the third device, a working channel of the third device to the working channel of the first device according to the working channel of the first device; or adjusting, by the third device, a working channel of the third device to the working channel of the second device according to the working channel of the second device.

According to a second aspect, a method for configuring a wireless device is provided, including receiving, by a second device, a second trigger message sent by a third device, where the second trigger message includes information about the third device and information about a first device, and the second trigger message is a second trigger message that is sent to the second device after the third device acquires information about the second device and shares a second key with the second device; and negotiating, by the second device according to the information about the third device and the information about the first device and based on authentication of the third device, with the first device to generate a third key, and establishing a connection with the first device using the third key, where the information about the first device is information that is about the first device, acquired by the third device by scanning a two-dimensional code of the first device, and corresponding to the two-dimensional code; or is information that is about the first device and acquired by the third device by means of NFC; or is information that is about the first device and acquired by the third device by means of short-range WiFi communication.

Based on the second aspect, in a first possible implementation manner, before the receiving, by a second device, a second trigger message sent by a third device, the method includes sending, by the second device, a two-dimensional code of the second device to the third device, and sharing the second key with the third device, such that the third device acquires the information that is about the second device and corresponding to the two-dimensional code; or sending the information about the second device to the third device by means of NFC, and sharing the second key with the third device; or sending the information about the second device to the third device by means of short-range WiFi communication, and sharing the second key with the third device.

Based on the second aspect or the first possible implementation manner of the second aspect, in a second possible implementation manner, the third device is a trusted third-party wireless device, includes one or more function modules or software programs, and is configured to implement one or more of the following: a man-machine interface function, a two-dimensional code identification function, a PIN function, a PBC function, an NFC function, and a short-range WiFi communication function.

Based on the second aspect, in a third possible implementation manner, the information about the first device includes a working channel of the first device, and the information about the third device includes a working channel of the third device; and after the receiving, by a second device, a second trigger message sent by a third device, the method includes adjusting, by the second device, a working channel of the second device to the working channel of the first device according to the working channel of the first device; or adjusting, by the second device, a working channel of the second device to the working channel of the third device according to the working channel of the third device.

According to a third aspect, a method for configuring a wireless device is provided, including receiving, by a first device, a first trigger message sent by a third device, where the first trigger message includes information about the third device; and negotiating, by the first device according to the information about the third device and based on authentication of the third device, with a second device to generate a third key, and establishing a connection between the first device and the second device using the third key.

Based on the third aspect, in a first possible implementation manner, before the receiving, by a first device, a first trigger message sent by a third device, the method includes sending, by the first device, a two-dimensional code of the first device to the third device, and sharing the first key with the third device, such that the third device acquires information that is about the first device and corresponding to the two-dimensional code, and sends the information about the first device to the second device; or sending information about the first device to the third device by means of NFC, and sharing the first key with the third device, such that the third device sends the information about the first device to the second device; or sending information about the first device to the third device by means of short-range WiFi communication, and sharing the first key with the third device, such that the third device sends the information about the first device to the second device.

Based on the third aspect or the first possible implementation manner of the third aspect, in a second possible implementation manner, the third device is a trusted third-party wireless device, includes one or more function modules or software programs, and is configured to implement one or more of the following: a man-machine interface function, a two-dimensional code identification function, a PIN function, a PBC function, an NFC function, and a short-range WiFi communication function.

Based on the third aspect, in a third possible implementation manner, the information about the third device includes a working channel of the third device; and after the receiving, by a first device, a first trigger message sent by a third device, the method includes adjusting, by the first device, a working channel of the first device to the working channel of the third device according to the working channel of the third device; or receiving, by the first device, information about the second device sent by the second device, where the information about the second device includes a working channel of the second device, and adjusting a working channel of the first device to the working channel of the second device.

According to a fourth aspect, an apparatus for configuring a wireless device is provided, where the apparatus is located on a side of a third device and includes an acquiring module configured to acquire information about a first device; a sharing module configured to share a first key with the first device; and a sending module configured to send a first trigger message to the first device, where the first trigger message includes information about the third device, where the acquiring module is further configured to acquire information about a second device; the sharing module is further configured to share a second key with the second device; and the sending module is further configured to send a second trigger message to the second device, where the second trigger message includes the information about the third device and the information about the first device, such that the second device negotiates, according to the information about the third device and the information about the first device and based on authentication of the third device, with the first device to generate a third key, and establishes a connection with the first device using the third key.

Based on the fourth aspect, in a first possible implementation manner, the acquiring module is configured to acquire, by scanning a two-dimensional code of the first/second device, the information that is about the first/second device and corresponding to the two-dimensional code; or acquire the information about the first/second device in an NFC manner; or acquire the information about the first/second device in a short-range WiFi communication manner.

Based on the first possible implementation manner of the fourth aspect, in a second possible implementation manner, the sharing module is configured to negotiate with the first/second device to generate the first/second key; or send the first/second key to the first/second device in the NFC/short-range WiFi communication manner, or receive the first/second key sent by the first/second device; or acquire, by scanning the two-dimensional code of the first/second device, the first/second key set by the first/second device.

Based on the fourth aspect or the first or second possible implementation manner of the fourth aspect, in a third possible implementation manner, the third device is a trusted third-party wireless device, includes one or more function modules or software programs, and is configured to implement one or more of the following: a man-machine interface function, a two-dimensional code identification function, a PIN function, a PBC function, an NFC function, and a short-range WiFi communication function.

Based on the first possible implementation manner of the fourth aspect, in a fourth possible implementation manner, the information about the first device includes a working channel of the first device, and the information about the second device includes a working channel of the second device; and the apparatus further includes an adjusting module configured to adjust a working channel of the third device to the working channel of the first device according to the working channel of the first device; or the adjusting module further configured to adjust a working channel of the third device to the working channel of the second device according to the working channel of the second device.

According to a fifth aspect, an apparatus for configuring a wireless device is provided, where the apparatus is located on a side of a second device and includes a receiving module configured to receive a second trigger message sent by the third device, where the second trigger message includes information about the third device and information about a first device, and the second trigger message is a second trigger message that is sent to the second device after the third device acquires information about the second device and shares a second key with the second device; and a connecting module configured to negotiate, according to the information about the third device and the information about the first device and based on authentication of the third device, with the first device to generate a third key, and establish a connection between the first device and the second device using the third key, where the information about the first device is information that is about the first device, acquired by the third device by scanning a two-dimensional code of the first device, and corresponding to the two-dimensional code; or is information that is about the first device and acquired by the third device by means of NFC; or is information that is about the first device and acquired by the third device by means of short-range WiFi communication.

Based on the fifth aspect, in a first possible implementation manner, the apparatus further includes a sharing module configured to send a two-dimensional code of the second device to the third device, and share the second key with the third device, such that the third device acquires the information that is about the second device and corresponding to the two-dimensional code; or send the information about the second device to the third device by means of NFC, and share the second key with the third device; or send the information about the second device to the third device by means of short-range WiFi communication, and share the second key with the third device.

Based on the fifth aspect or the first possible implementation manner of the fifth aspect, in a second possible implementation manner, the third device is a trusted third-party wireless device, includes one or more function modules or software programs, and is configured to implement one or more of the following: a man-machine interface function, a two-dimensional code identification function, a PIN function, a PBC function, an NFC function, and a short-range WiFi communication function.

Based on the fifth aspect, in a third possible implementation manner, the information about the first device includes a working channel of the first device, and the information about the third device includes a working channel of the third device; and the apparatus further includes an adjusting module configured to adjust a working channel of the second device to the working channel of the first device according to the working channel of the first device; or adjust a working channel of the second device to the working channel of the third device according to the working channel of the third device.

According to a sixth aspect, an apparatus for configuring a wireless device is provided, where the apparatus is located on a side of a first device and includes a receiving module configured to receive a first trigger message sent by a third device, where the first trigger message includes information about the third device; and a connecting module configured to negotiate, according to the information about the third device and based on authentication of the third device, with a second device to generate a third key, and establish a connection between the first device and the second device using the third key.

Based on the sixth aspect, in a first possible implementation manner, the apparatus further includes a sharing module that is configured to send a two-dimensional code of the first device to the third device, and share the first key with the third device, such that the third device acquires information that is about the first device and corresponding to the two-dimensional code, and sends the information about the first device to the second device; or send information about the first device to the third device by means of short-range WiFi communication, and share the first key with the third device, such that the third device sends the information about the first device to the second device.

Based on the sixth aspect or the first possible implementation manner of the sixth aspect, in a second possible implementation manner, the third device is a trusted third-party wireless device, includes one or more function modules or software programs, and is configured to implement one or more of the following: a man-machine interface function, a two-dimensional code identification function, a PIN function, a PBC function, an NFC function, and a short-range WiFi communication function.

Based on the first possible implementation manner of the sixth aspect, in a third possible implementation manner, the information about the third device includes a working channel of the third device; and the apparatus further includes an adjusting module configured to adjust a working channel of the first device to the working channel of the third device according to the working channel of the third device; or receive information about the second device sent by the second device, where the information about the second device includes a working channel of the second device, and adjust a working channel of the first device to the working channel of the second device.

According to a seventh aspect, a system for configuring a wireless device is provided, including a first device, a second device, and a third device, where the first device includes the apparatus for configuring a wireless device according to the sixth aspect; the second device includes the apparatus for configuring a wireless device according to the fifth aspect; and the third device includes the apparatus for configuring a wireless device according to the fourth aspect.

In the embodiments of the present disclosure, a trusted third-party wireless device (a third device) separately shares a first key with a first device and sends a first trigger message including information about the third device to the first device, and shares a second key with a second device and sends a second trigger message including the information about the third device and information about the first device to the second device, such that the second device negotiates, according to the information about the third device and the information about the first device and based on authentication of the third device, with the first device to generate a third key, and establishes a connection between the first device and the second device using the third key; therefore, when neither of two wireless devices that are to establish WiFi P2P communication has an input device (such as a keyboard) or a display device (such as a screen), and supported authentication configuration methods are different, the two wireless devices may establish a connection for WiFi P2P communication between the two wireless devices based on the authentication of the third device; further, when a wireless device that is to join a WLAN set by an AP does not have an input device or a display device, and supports only a two-dimensional code method, this wireless device may join, based on the authentication of the third device, the WLAN set by the AP. Therefore, a problem that existing WPS authentication configuration has a relatively high requirement on performance of a wireless device may be resolved, and protocol content of the existing WPS authentication configuration is extended.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show some embodiments of the present disclosure, and persons of ordinary skill in the art may still derive other drawings from these accompanying drawings without creative efforts.

FIG. 1 is a schematic flowchart of a method for configuring a wireless device according to an embodiment of the present disclosure;

FIG. 2 is a schematic flowchart of a method for configuring a wireless device according to another embodiment of the present disclosure;

FIG. 3 is a schematic flowchart of a method for configuring a wireless device according to another embodiment of the present disclosure;

FIG. 4 is a signaling diagram of a method for configuring a wireless device according to another embodiment of the present disclosure;

FIG. 5 is a signaling diagram of a method for configuring a wireless device according to another embodiment of the present disclosure;

FIG. 6 is a schematic structural diagram of an apparatus for configuring a wireless device according to another embodiment of the present disclosure;

FIG. 7 is a schematic structural diagram of an apparatus for configuring a wireless device according to another embodiment of the present disclosure;

FIG. 8 is a schematic structural diagram of an apparatus for configuring a wireless device according to another embodiment of the present disclosure;

FIG. 9 is a schematic structural diagram of an apparatus for configuring a wireless device according to another embodiment of the present disclosure;

FIG. 10 is a schematic structural diagram of an apparatus for configuring a wireless device according to another embodiment of the present disclosure;

FIG. 11 is a schematic structural diagram of an apparatus for configuring a wireless device according to another embodiment of the present disclosure; and

FIG. 12 is a schematic structural diagram of a system for configuring a wireless device according to another embodiment of the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are some but not all of the embodiments of the present disclosure. All other embodiments obtained by persons of ordinary skill in the art based on the embodiments of the present disclosure without creative efforts shall fall within the protection scope of the present disclosure.

The technical solutions of the present disclosure may be applied to various WLANs, especially an application scenario based on WPS, where a first device and a second device are different wireless devices, and a third device is a trusted third-party wireless device, has an input device and a display device, and supports at least one of a two-dimensional code identification function, a PIN function, a PBC function, an NFC function, and a short-range WiFi communication function.

When neither the first device nor the second device has an input device (such as a keyboard) or a display device (such as a screen), and authentication configuration methods supported by the first device and the second device are different, the first device and the second device cannot perform existing WPS authentication configuration to establish a secure connection of WiFi P2P communication between the first device and the second device.

For example, the first device supports only an NFC method, and the second device does not support the NFC method; or the first device supports only a two-dimensional code method, and the second device does not support the two-dimensional code method; or the first device supports only a PIN method, and the second device does not support the PIN method; or the like. The first device and the second device cannot perform the existing WPS authentication configuration to establish the secure connection of WiFi P2P communication between the first device and the second device.

For example, when the first device is an AP, and generally an AP does not have an input device or a display device, and further when the second device does not have an input device or a display device and supports only the two-dimensional code method, the second device cannot perform the existing WPS authentication configuration to join a WLAN set by the AP.

Therefore, in the existing WPS authentication configuration, a requirement on performance of a wireless device is relatively high. To enable any wireless devices with different performance to perform WPS authentication configuration and establish a secure connection of WiFi P2P communication between two wireless devices, or to enable any wireless device with different performance to join a WLAN set by an AP, the embodiments of the present disclosure provide a method for configuring a wireless device, and the method can resolve a problem that the existing WPS authentication configuration has a relatively high requirement on performance of a wireless device.

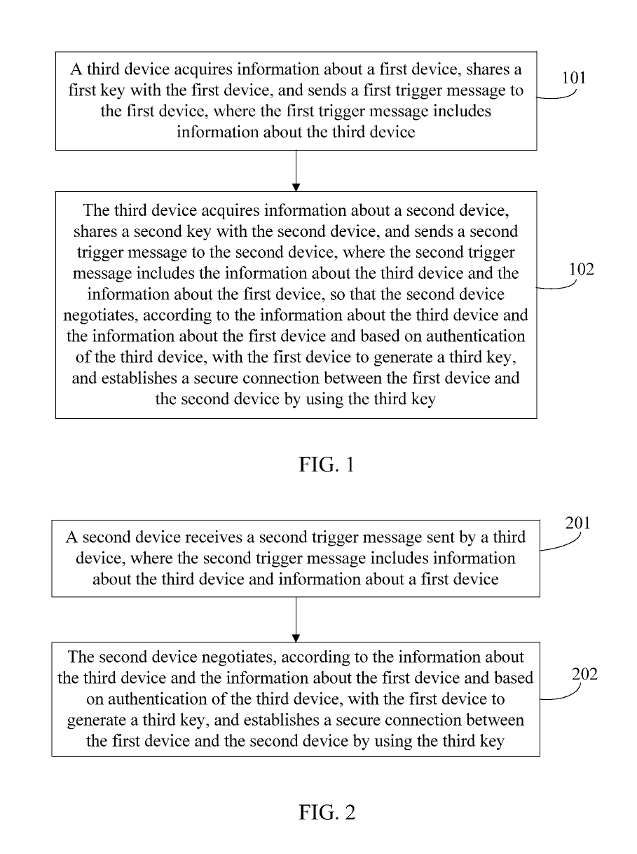

FIG. 1 is a schematic flowchart of a method for configuring a wireless device according to an embodiment of the present disclosure. As shown in FIG. 1, the method for configuring a wireless device in this embodiment may include the following steps.

101. A third device acquires information about a first device, shares a first key with the first device, and sends a first trigger message to the first device, where the first trigger message includes information about the third device.

In an optional implementation manner of the present disclosure, the acquiring, by a third device, information about a first device includes, when the first device has a two-dimensional code, acquiring, by the third device and by scanning the two-dimensional code of the first device, information that is about the first device and corresponding to the two-dimensional code; or when the first device supports an NFC function, acquiring, by the third device, the information about the first device by means of NFC; or when the first device supports a short-range WiFi communication function, acquiring, by the third device, the information about the first device by means of short-range WiFi communication.

In an optional implementation manner of the present disclosure, the sharing, by a third device, a first key with the first device includes negotiating, by the third device, with the first device to generate the first key; or sending, by the third device, the first key to the first device by means of NFC, or receiving the first key sent by the first device; or acquiring, by the third device and by scanning the two-dimensional code of the first device, the first key set by the first device.

In an optional implementation manner of the present disclosure, after the sharing, by a third device, a first key with the first device, the method includes the following steps.

The third device may share a third key with the first device using the first key. For example, the third device generates the third key using the first key, or the third device randomly generates the third key, encrypts the third key using the first key, and sends an encrypted third key to the first device (for example, sending the third key to the first device using the first trigger message), or the first device randomly generates the third key using the first key, encrypts the third key using the first key, and sends an encrypted third key to the third device, or the first device negotiates with the third device to generate the third key. The third key is used by the second device to establish a secure connection between the first device and the second device using the third key.

The information about the third device includes but is not limited to information such as an identifier of the third device and a working channel of the third device.

The information that is about the first device and acquired by the third device includes but is not limited to information such as an identifier of the first device, a working channel of the first device, and an authentication configuration method supported by the first device.

When the foregoing working channel of the third device is different from the working channel of the first device, to subsequently transfer a message between the first device and the third device, the third device may adjust the working channel of the third device to the working channel of the first device, or the first device may adjust the working channel of the first device to the working channel of the third device. It should be noted that, when the first device is an AP, because a working channel of an AP is fixed, the third device needs to adjust the working channel of the third device to the working channel of the first device.

102. The third device acquires information about a second device, shares a second key with the second device, and sends a second trigger message to the second device, where the second trigger message includes the information about the third device and the information about the first device, such that the second device negotiates, according to the information about the third device and the information about the first device and based on authentication of the third device, with the first device to generate a third key, and establishes a secure connection between the first device and the second device using the third key.

In an optional implementation manner of the present disclosure, the acquiring, by the third device, information about a second device includes acquiring, by the third device and by scanning a two-dimensional code of the second device, the information that is about the second device and corresponding to the two-dimensional code; or acquiring, by the third device, the information about the second device by means of NFC; or acquiring, by the third device, the information about the second device by means of short-range WiFi communication.

In an optional implementation manner of the present disclosure, the sharing, by the third device, a second key with the second device includes negotiating, by the third device, with the second device to generate the second key; or sending, by the third device, the second key to the second device by means of NFC, or receiving the second key sent by the second device; or acquiring, by the third device and by scanning the two-dimensional code of the second device, the second key set by the second device.

In an optional implementation manner of the present disclosure, when the negotiating, by the second device according to the information about the third device and the information about the first device and based on authentication of the third device, with the first device to generate a third key is implemented, the following is included.

For example, the second device generates a random number NA, encrypts the random number NA, a session identifier (sess), an identifier of the second device or a first plaintext (A), and the identifier of the first device or a second plaintext (B) using the second key, and sends an encrypted random number NA, sess, A, and B, and the unencrypted A, B, and sess together to the first device.

The first device generates a random number NB, encrypts the random number NB, the session identifier (sess), the identifier of the second device or the first plaintext (A), and the identifier of the first device or the second plaintext (B) using the first key, and sends an encrypted random number NB, A, B, and sess, the unencrypted A, B, and sess, and the encrypted random number NA to the third device.

After receiving the encrypted random number NB and the encrypted random number NA, the third device decrypts the random number NB using the first key, decrypts the NA using the second key, generates the third key according to the random number NA and the random number NB, encrypts the third key and the NA using the second key, encrypts the third key and the NB using the first key, and sends an encrypted third key and NB, and an encrypted third key and NA to the first device.

The first device decrypts the third key using the first key, and sends the third key and NA encrypted by the third device using the second key to the second device.

The second device decrypts the third key using the second key.

For another example, the second device generates a random number ga, where the ga is a second public key ga generated by the second device, the ga is generated according to a private key a, the second device reserves the private key a, and the private key a is a random number generated by the second device; encrypts the random number ga, sess, A, and B using the second key, where the sess, A, and B are a session identifier (sess), an identifier of the second device or a first plaintext (A), and the identifier of the first device or a second plaintext (B); and sends an encrypted random number ga, sess, A, and B, and the unencrypted A, sees, and NA to the first device.

The first device generates a random number gb, where the gb is a first public key gb generated by the first device, the gb is generated according to a private key b, the first device reserves the private key b, and the private key b is a random number generated by the first device; encrypts the random number gb, sess, A, and B using the first key, and receives an encrypted packet (the encrypted random number ga, sees, A, and B) of the second device; and sends the encrypted random number ga, sess, A, and B, the received encrypted packet of the second device, and the unencrypted B and sees to the third device.

After receiving the encrypted random number ga and an encrypted random number gb, the third device decrypts the random number gb using the first key, decrypts the random number ga using the second key, obtains a first encrypted value by encrypting the random numbers ga and gb, sess, A, and B using the second key, then encrypts the first encrypted value and the random numbers ga and gb, sess, A, and B using the first key, and sends an encrypted first encrypted value, random numbers ga, gb, sess, A, and B to the first device.

The first device decrypts the random number ga and the random number gb using the first key, and sends the first encrypted value to the second device.

The second device decrypts the random number ga and the random number gb using the second key.

Then, the first device obtains, by calculation, the third key using the decrypted random number ga and random number gb, and the second device obtains, by calculation, the third key using the decrypted random number ga and random number gb.

A process of obtaining the third key belongs to a process of securely obtaining a shared key using a public and private key algorithm, and various implementation manners of an existing public and private key algorithm may be used. Commonly used public and private key algorithms include: a) Diffie-Hellman (D-H) algorithm, b) Rivest-Shamir-Adleman (RSA) algorithm, and c) ElGamal algorithm.

The foregoing algorithms are several commonly used examples in a public and private key algorithm: a device generates a public key according to a private key, where the public key may be open, but the private key needs to be kept private.

In this embodiment, the first or second key may be a symmetric key.

In an optional implementation manner of the present disclosure, the first or second key may also be a public key of an asymmetric key, and the first or second device may reserve a private key corresponding to the first or second key. When the negotiating, by the second device according to the information about the third device and the information about the first device and based on authentication of the third device, with the first device to generate a third key is implemented, the following is included.

For example, the second device generates a random number NA, encrypts the random number NA, a session identifier (sess), an identifier of the second device or a first plaintext (A), and the identifier of the first device or a second plaintext (B) using the private key corresponding to the second key, and sends a random number NA, sess, A, and B encrypted using the private key corresponding to the second key, and the unencrypted A, B, and sess together to the first device.

The first device generates a random number NB, encrypts the random number NB, the session identifier (sess), the identifier of the second device or the first plaintext (A), and the identifier of the first device or the second plaintext (B) using the private key corresponding to the first key, and sends a random number NB, A, B, and sess encrypted using the private key corresponding to the first key, the unencrypted A, B, and sess, and a random number NA, sess, A, and B encrypted using the private key corresponding to the second key to the third device.

After receiving the random number NB, A, B, and sess encrypted using the private key corresponding to the first key, the unencrypted A, B, and sess, and the random number NA, sess, A, and B encrypted using the private key corresponding to the second key, the third device decrypts the random number NB using the first key, decrypts the random number NA using the second key, generates the third key according to the random number NA and the random number NB, encrypts the third key and the NA using the second key, encrypts the third key and the NB using the first key, and sends an encrypted third key and NB, and an encrypted third key and NA to the first device.

The first device decrypts the third key using the private key corresponding to the first key, and sends the third key and NA encrypted by the third device using the second key to the second device.

The second device decrypts the third key using the private key corresponding to the second key.

Alternatively, the second device generates a random number ga, where the ga is a second public key ga generated by the second device, the ga is generated according to a private key a, the second device reserves the private key a, and the private key a is a random number generated by the second device; the second device encrypts the random number ga, sess, A, and B using the private key corresponding to the second key, where the sess, A, and B are a session identifier (sess), an identifier of the second device or a first plaintext (A), and the identifier of the first device or a second plaintext (B); and sends an encrypted random number ga, sess, A, and B encrypted using the private key corresponding to the second key, and the unencrypted A, sess, and NA to the first device.

The first device generates a random number gb, where the gb is a first public key gb generated by the first device, the gb is generated according to a private key b, the first device reserves the private key b, and the private key b is a random number generated by the first device; encrypts the random number gb, sess, A, and B using the private key corresponding to the first key, and receives an encrypted packet (the random number ga, sess, A, and B encrypted using the private key corresponding to the second key) of the second device; and sends the random number ga, sess, A, and B encrypted using the private key corresponding to the first key, the received encrypted packet of the second device, and the unencrypted A, B, and sess to the third device.

After receiving an encrypted random number ga and the encrypted random number gb, the third device decrypts the random number gb using the first key, decrypts the random number ga using the second key, obtains a first encrypted value by encrypting the random numbers ga and gb, sess, A, and B using the second key, then encrypts the first encrypted value and the random numbers ga and gb, sess, A, and B using the first key, and sends an encrypted first encrypted value, random numbers ga, gb, sess, A, and B to the first device.

The first device decrypts the random number ga and the random number gb using the private key corresponding to the first key, and sends the first encrypted value to the second device.

The second device decrypts the random number ga and the random number gb using the private key corresponding to the second key. Then, the first device obtains, by calculation, the decrypted third key using the random number ga and random number gb, and the second device obtains, by calculation, the third key using the decrypted random number ga and random number gb.

In a public and private key algorithm, a device generates a pair of public and private keys, where the public key may be open, and the private key needs to be kept private. Information encrypted using the public key can only be decrypted using a private key corresponding to the public key, and information encrypted using the private key can only be decrypted using a public key corresponding to the private key.

In this embodiment of the present disclosure, the shared key (the shared first or second key) is set as a public key in a public and private key system, where the shared first key is a public key of the first device, and the shared second key is a public key of the second device. Information encrypted using the first key needs to be decrypted using a corresponding private key, and information encrypted using a private key corresponding to the first key needs to be decrypted using a first public key; information encrypted using the second key needs to be decrypted using a corresponding private key, and information encrypted using a private key corresponding to the second key needs to be decrypted using a second public key. When the third device communicates with the first device and the second device, because the third device can collect a correct first key and second key, the private key corresponding to the first key is kept by the first device and is not sent out, and the private key corresponding to the second key is kept by the second device and is not sent out, an attacker can only obtain a public key of the first key or the second key, but cannot obtain the private key corresponding to the first key or the second key, and therefore cannot decrypt information encrypted using the public key of the first key or the second key, cannot implement eavesdropping and man-in-the-middle attack, and cannot obtain privacy information of the third device, the first device, and the second device. Privacy of a user is protected, and also man-in-the-middle attack caused by using a public and private key algorithm is overcome, thereby further improving security.

In an optional implementation manner of the present disclosure, if the third device shares the third key with the first device using the first key, the second trigger message sent by the third device to the second device may further include the third key, and further, the third device may encrypt the third key using the second key and send the encrypted third key to the second device.

Correspondingly, the second device may establish the secure connection with the first device using the third key according to the information about the third device and the information about the first device. In an implementation, the second device may perform WPS authentication configuration or a four-way handshake with the first device using the third key. For a specific procedure of the WPS authentication configuration or the four-way handshake, reference may be made to an existing WPS standard, and details are not described again.

The information that is about the second device and acquired by the third device includes but is not limited to information such as the identifier of the second device, a working channel of the second device, and an authentication configuration method supported by the second device.

To subsequently transfer a message between the first device, the second device, and the third device, working channels of the first device, the second device, and the third device need to be adjusted to a same working channel; that is, working channels of the first device and the second device may be adjusted to the working channel of the third device, or working channels of the first device and the third device may be adjusted to the working channel of the second device, or working channels of the second device and the third device may be adjusted to the working channel of the first device.

It should be noted that, because the working channel of an AP is fixed, when the first device is an AP, the working channels of the second device and the third device need to be adjusted to the working channel of the first device; when the second device is an AP, the working channels of the first device and the third device need to be adjusted to the working channel of the second device.

In this embodiment of the present disclosure, a trusted third-party wireless device (a third device) separately shares a first key with a first device and sends a first trigger message including information about the third device to the first device, and shares a second key with a second device and sends a second trigger message including the information about the third device and information about the first device to the second device, such that the second device negotiates, according to the information about the third device and the information about the first device and based on authentication of the third device, with the first device to generate a third key, and establishes a secure connection between the first device and the second device using the third key; further, after sharing the first key with the first device, the trusted third device shares the third key with the first device using the first key and sends the third key to the second device, such that the second device establishes the secure connection between the first device and the second device directly using the third key; therefore, when neither of two wireless devices that are to establish WiFi P2P communication has an input device (such as a keyboard) or a display device (such as a screen), and supported authentication configuration methods are different, the two wireless devices may establish a secure connection for WiFi P2P communication between the two wireless devices based on the authentication of the third device; further, when a wireless device that is to join a WLAN set by an AP does not have an input device or a display device, and supports only a two-dimensional code method, this wireless device may join, based on the authentication of the third device, the WLAN set by the AP. Therefore, a problem that existing WPS authentication configuration has a relatively high requirement on performance of a wireless device may be resolved, and protocol content of the existing WPS authentication configuration is extended.

FIG. 2 is a schematic flowchart of a method for configuring a wireless device according to another embodiment of the present disclosure. As shown in FIG. 2, the following steps are included.

201. A second device receives a second trigger message sent by a third device, where the second trigger message includes information about the third device and information about a first device.

In an optional implementation manner of the present disclosure, before step 201, the method includes sending, by the second device, a two-dimensional code of the second device to the third device, and sharing a second key with the third device, such that the third device acquires information that is about the second device and corresponding to the two-dimensional code; or sending, by the second device, information about the second device to the third device by means of NFC, and sharing a second key with the third device; or sending, by the second device, information about the second device to the third device by means of short-range WiFi communication, and sharing a second key with the third device.

The information about the first device is information that is about the first device, acquired by the third device by scanning a two-dimensional code of the first device, and corresponding to the two-dimensional code; or is information that is about the first device and acquired by the third device by means of NFC; or is information that is about the first device and acquired by the third device by means of short-range WiFi communication.

The information about the first device includes but is not limited to information such as an identifier of the first device, a working channel of the first device, and an authentication configuration method supported by the first device. The information about the third device includes but is not limited to information such as an identifier of the third device and a working channel of the third device.

To subsequently transfer a message between the first device, the second device, and the third device, working channels of the first device, the second device, and the third device need to be adjusted to a same working channel; that is, after receiving the information about the first device and the information about the third device, the second device may adjust the working channel of the second device to the working channel of the first device or the working channel of the third device. It should be noted that, when the second device is an AP, because a working channel of an AP is fixed, the second device needs to send information about the working channel of the second device to the third device and the first device using the information about the second device, such that the first device and the third device adjust their respective working channels to the working channel of the AP according to the information about the working channel of the second device.

In an optional implementation manner of the present disclosure, if the second trigger message further includes a third key, where the third key is a third key shared with the first device using a first key after the third device acquires the information about the first device and shares the first key with the first device according to the information about the first device, after the receiving, by a second device, a second trigger message sent by a third device, the method includes establishing, by the second device, a secure connection between the first device and the second device using the third key. In an implementation, the second device may perform WPS authentication configuration or a four-way handshake with the first device using the third key. For a procedure of the WPS authentication configuration or the four-way handshake, reference may be made to an existing WPS standard, and details are not described again.

202. The second device negotiates, according to the information about the third device and the information about the first device and based on authentication of the third device, with the first device to generate a third key, and establishes a secure connection between the first device and the second device using the third key.

In an optional implementation manner of the present disclosure, when the negotiating, by the second device according to the information about the third device and the information about the first device and based on authentication of the third device, with the first device to generate a third key is implemented, the following is included.

For example, the second device generates a random number NA, encrypts the random number NA, a session identifier (sess), an identifier of the second device or a first plaintext (A), and the identifier of the first device or a second plaintext (B) using the second key, and sends an encrypted random number NA, sess, A, and B, and the unencrypted A, B, and sess together to the first device.

The first device generates a random number NB, encrypts the random number NB, the session identifier (sess), the identifier of the second device or the first plaintext (A), and the identifier of the first device or the second plaintext (B) using the first key, and sends an encrypted random number NB, A, B, and sess, the unencrypted A, B, and sess, and the encrypted random number NA to the third device.

After receiving the encrypted random number NB and the encrypted random number NA, the third device decrypts the random number NB using the first key, decrypts the NA using the second key, generates the third key according to the random number NA and the random number NB, encrypts the third key and the NA using the second key, encrypts the third key and the NB using the first key, and sends an encrypted third key and NB, and an encrypted third key and NA to the first device.

The first device decrypts the third key using the first key, and sends the third key and NA encrypted by the third device using the second key to the second device.

The second device decrypts the third key using the second key.

For another example, the second device generates a random number ga, where the ga is a second public key ga generated by the second device, the ga is generated according to a private key a, the second device reserves the private key a, and the private key a is a random number generated by the second device; encrypts the random number ga, sess, A, and B using the second key, where the sess, A, and B are a session identifier (sess), an identifier of the second device or a first plaintext (A), and the identifier of the first device or a second plaintext (B); and sends an encrypted random number ga, sess, A, and B, and the unencrypted A, sess, and NA to the first device.

The first device generates a random number gb, where the gb is a first public key gb generated by the first device, the gb is generated according to a private key b, the first device reserves the private key b, and the private key b is a random number generated by the first device; encrypts the random number gb, sess, A, and B using the first key, and receives an encrypted packet (the encrypted random number ga, sess, A, and B) of the second device; and sends the encrypted random number ga, sess, A, and B, the received encrypted packet of the second device, and the unencrypted B and sees to the third device.

After receiving the encrypted random number ga and an encrypted random number gb, the third device decrypts the random number gb using the first key, decrypts the random number ga using the second key, obtains a first encrypted value by encrypting the random numbers ga and gb, sess, A, and B using the second key, then encrypts the first encrypted value and the random numbers ga and gb, sess, A, and B using the first key, and sends an encrypted first encrypted value, random numbers ga, gb, sess, A, and B to the first device.

The first device decrypts the random number ga and the random number gb using the first key, and sends the first encrypted value to the second device.

The second device decrypts the random number ga and the random number gb using the second key.

Then, the first device obtains, by calculation, the third key using the decrypted random number ga and random number gb, and the second device obtains, by calculation, the third key using the decrypted random number ga and random number gb.

In this embodiment, the first or second key may be a symmetric key.

In an optional implementation manner of the present disclosure, the first or second key may also be a public key of an asymmetric key, and the first or second device may reserve a private key corresponding to the first or second key. When the negotiating, by the second device according to the information about the third device and the information about the first device and based on authentication of the third device, with the first device to generate a third key is implemented, the following is included.

For example, the second device generates a random number NA, encrypts the random number NA, a session identifier (sess), an identifier of the second device or a first plaintext (A), and the identifier of the first device or a second plaintext (B) using the private key corresponding to the second key, and sends a random number NA, sess, A, and B encrypted using the private key corresponding to the second key, and the unencrypted A, B, and sess together to the first device.

The first device generates a random number NB, encrypts the random number NB, the session identifier (sess), the identifier of the second device or the first plaintext (A), and the identifier of the first device or the second plaintext (B) using the private key corresponding to the first key, and sends a random number NB, A, B, and sess encrypted using the private key corresponding to the first key, the unencrypted A, B, and sess, and a random number NA, sess, A, and B encrypted using the private key corresponding to the second key to the third device.

After receiving the random number NB, A, B, and sess encrypted using the private key corresponding to the first key, the unencrypted A, B, and sess, and the random number NA, sess, A, and B encrypted using the private key corresponding to the second key, the third device decrypts the random number NB using the first key, decrypts the random number NA using the second key, generates the third key according to the random number NA and the random number NB, encrypts the third key and the NA using the second key, encrypts the third key and the NB using the first key, and sends an encrypted third key and NB, and an encrypted third key and NA to the first device.

The first device decrypts the obtained third key using the private key corresponding to the first key, and sends the third key and NA encrypted by the third device using the second key to the second device.

The second device decrypts the obtained third key using the private key corresponding to the second key.

Alternatively, the second device generates a random number ga, where the ga is a second public key ga generated by the second device, the ga is generated according to a private key a, the second device reserves the private key a, and the private key a is a random number generated by the second device; the second device encrypts the random number ga, sess, A, and B using the private key corresponding to the second key, where the sess, A, and B are a session identifier (sess), an identifier of the second device or a first plaintext (A), and the identifier of the first device or a second plaintext (B); and sends an encrypted random number ga, sess, A, and B encrypted using the private key corresponding to the second key, and the unencrypted A, sess, and NA to the first device.

The first device generates a random number gb, where the gb is a first public key gb generated by the first device, the gb is generated according to a private key b, the first device reserves the private key b, and the private key b is a random number generated by the first device; encrypts the random number gb, sess, A, and B using the private key corresponding to the first key, and receives an encrypted packet (the random number ga, sess, A, and B after using the private key corresponding to the second key) of the second device; and sends the random number ga, sess, A, and B encrypted using the private key corresponding to the first key, the received encrypted packet of the second device, and the unencrypted A, B, and sess to the third device.

After receiving an encrypted random number ga and the encrypted random number gb, the third device decrypts the random number gb using the first key, decrypts the random number ga using the second key, obtains a first encrypted value by encrypting the random numbers ga and gb, sess, A, and B using the second key, then encrypts the first encrypted value and the random numbers ga and gb, sess, A, and B using the first key, and sends an encrypted first encrypted value, random numbers ga, gb, sess, A, and B to the first device.

The first device decrypts the random number ga and the random number gb using the private key corresponding to the first key, and sends the first encrypted value to the second device.

The second device decrypts the random number ga and the random number gb using the private key corresponding to the second key. Then, the first device obtains, by calculation, the decrypted third key using the random number ga and random number gb, and the second device obtains, by calculation, the third key using the decrypted random number ga and random number gb.

In this embodiment of the present disclosure, the shared key (the shared first or second key) is set as a public key in a public and private key system, where the shared first key is a public key of the first device, and the shared second key is a public key of the second device. Information encrypted using the first key needs to be decrypted using a corresponding private key, and information encrypted using a private key corresponding to the first key needs to be decrypted using a first public key; information encrypted using the second key needs to be decrypted using a corresponding private key, and information encrypted using a private key corresponding to the second key needs to be decrypted using a second public key. When the third device communicates with the first device and the second device, because the third device can collect a correct first key and second key, the private key corresponding to the first key is kept by the first device and is not sent out, and the private key corresponding to the second key is kept by the second device and is not sent out, an attacker can only obtain a public key of the first key or the second key, but cannot obtain the private key corresponding to the first key or the second key, and therefore cannot decrypt information encrypted using the public key of the first key or the second key, cannot implement eavesdropping and man-in-the-middle attack, and cannot obtain privacy information of the third device, the first device, and the second device. Privacy of a user is protected, and also man-in-the-middle attack caused by using a public and private key algorithm is overcome, thereby further improving security.

In this embodiment of the present disclosure, a trusted third-party wireless device (a third device) separately shares a first key with a first device and sends a first trigger message including information about the third device to the first device, and shares a second key with a second device and sends a second trigger message including the information about the third device and information about the first device to the second device, such that the second device negotiates, according to the information about the third device and the information about the first device and based on authentication of the third device, with the first device to generate a third key, and establishes a secure connection between the first device and the second device using the third key; further, after sharing the first key with the first device, the trusted third device shares the third key with the first device using the first key and sends the third key to the second device, such that the second device establishes the secure connection between the first device and the second device directly using the third key; therefore, when neither of two wireless devices that are to establish WiFi P2P communication has an input device (such as a keyboard) or a display device (such as a screen), and supported authentication configuration methods are different, the two wireless devices may establish a secure connection for WiFi P2P communication between the two wireless devices based on the authentication of the third device; further, when a wireless device that is to join a WLAN set by an AP does not have an input device or a display device, and supports only a two-dimensional code method, this wireless device may join, based on the authentication of the third device, the WLAN set by the AP. Therefore, a problem that existing WPS authentication configuration has a relatively high requirement on performance of a wireless device may be resolved, and protocol content of the existing WPS authentication configuration is extended.

FIG. 3 is a schematic flowchart of a method for configuring a wireless device according to another embodiment of the present disclosure. As shown in FIG. 3, the following steps are included.

301. A first device receives a first trigger message sent by a third device, where the first trigger message includes information about the third device.

In an optional implementation manner of the present disclosure, before step 301, the method includes sending, by the first device, a two-dimensional code of the first device to the third device, and sharing a first key with the third device, such that the third device acquires information that is about the first device and corresponding to the two-dimensional code; or sending, by the first device, information about the first device to the third device by means of NFC, and sharing a first key with the third device; or sending, by the first device, information about the first device to the third device by means of short-range WiFi communication, and sharing a first key with the third device.

The foregoing information about the first device includes but is not limited to information such as an identifier of the first device, a working channel of the first device, and an authentication configuration method supported by the first device. The information about the third device includes but is not limited to information such as an identifier of the third device and a working channel of the first device.

It should be noted that, to subsequently transfer a message between the first device and the third device, the working channel of the first device and the working channel the third device need to be the same. After receiving the first trigger message, the first device adjusts the working channel of the first device to the working channel of the third device according to the information about the third device included in the first trigger message. When it is assumed that the first device is an AP, because a working channel of an AP is fixed, the first device may send information about the working channel of the first device to the third device using the information about the first device, such that the third device adjusts the working channel of the third device to the working channel of the first device.

In an optional implementation manner of the present disclosure, after it is assumed that the first device shares the first key with the third device, the method includes the following.

The first device may share a third key with the third device using the first key. For example, the third device generates the third key using the first key, encrypts the third key using the first key, and sends an encrypted third key to the first device (for example, sending the third key to the first device using the first trigger message); or the third device randomly generates the third key, encrypts the third key using the first key, and sends an encrypted third key to the first device (for example, sending the third key to the first device using the first trigger message); or the first device randomly generates the third key using the first key, encrypts the third key using the first key, and sends an encrypted third key to the third device; or the first device negotiates with the third device to generate the third key.

Then, the third device may encrypt the third key using the second key and sends an encrypted third key (for example, using a second trigger message) to the second device, such that the second device establishes a secure connection between the first device and the second device using the third key.

302. The first device negotiates, according to the information about the third device and based on authentication of the third device, with a second device to generate a third key, and establishes a secure connection between the first device and the second device using the third key.

In an optional implementation manner of the present disclosure, after receiving the information about the first device and the information about the third device, the second device may send an indication message to the first device, such that the first device initiates an authentication procedure that is based on the third device, and negotiates with the second device to generate the third key. In an implementation, reference may be made to a related description in the embodiment shown in FIG. 1, and details are not described again.

To subsequently transfer a message between the first device, the second device, and the third device, working channels of the first device, the second device, and the third device need to be adjusted to a same working channel; that is, after receiving the information about the first device and the information about the third device, the second device may adjust the working channel of the second device to the working channel of the first device or the working channel of the third device. It should be noted that, when the second device is an AP, because the working channel of an AP is fixed, the second device needs to send information about the working channel of the second device to the third device and the first device using the information about the second device, such that the first device and the third device adjust their respective working channels to the working channel of the AP according to the information about the working channel of the second device. The information about the second device may be sent to the third device in the foregoing process (that is, using a two-dimensional code or an NFC method or short-range WiFi communication) of performing, by the third device, WPS authentication configuration with the second device, and the third device may send the acquired information about the second device to the first device.

In this embodiment of the present disclosure, a trusted third-party wireless device (a third device) separately shares a first key with a first device and sends a first trigger message including information about the third device to the first device, and shares a second key with a second device and sends a second trigger message including the information about the third device and information about the first device to the second device, such that the second device negotiates, according to the information about the third device and the information about the first device and based on authentication of the third device, with the first device to generate a third key, and establishes a secure connection between the first device and the second device using the third key; further, after sharing the first key with the first device, the trusted third device shares the third key with the first device using the first key and sends the third key to the second device, such that the second device establishes the secure connection between the first device and the second device directly using the third key; therefore, when neither of two wireless devices that are to establish WiFi P2P communication has an input device (such as a keyboard) or a display device (such as a screen), and supported authentication configuration methods are different, the two wireless devices may establish a secure connection for WiFi P2P communication between the two wireless devices based on the authentication of the third device; further, when a wireless device that is to join a WLAN set by an AP does not have an input device or a display device, and supports only a two-dimensional code method, this wireless device may join, based on the authentication of the third device, the WLAN set by the AP. Therefore, a problem that existing WPS authentication configuration has a relatively high requirement on performance of a wireless device may be resolved, and protocol content of the existing WPS authentication configuration is extended.

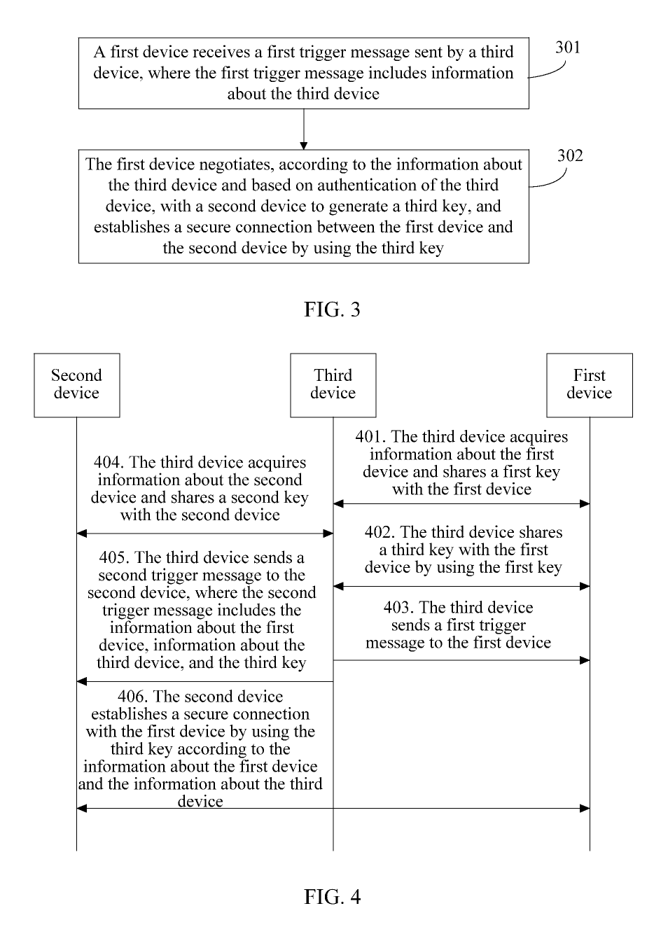

FIG. 4 is a signaling diagram of a method for configuring a wireless device according to another embodiment of the present disclosure. As shown in FIG. 4, the following steps are included.

401. A third device acquires information about a first device and shares a first key with the first device.

In an implementation, for example, when the first device has a two-dimensional code, the third device acquires, by scanning the two-dimensional code of the first device, information that is about the first device and corresponding to the two-dimensional code, and negotiates with the first device to generate the first key.

Alternatively, when the first device supports an NFC function, the third device acquires the information about the first device by means of NFC, and negotiates with the first device to generate the first key.

Alternatively, when the first device supports a short-range WiFi communication function, the third device acquires the information about the first device by means of short-range WiFi communication, and negotiates with the first device to generate the first key.

The information that is about the first device and acquired by the third device includes but is not limited to information such as an identifier of the first device, a working channel of the first device, and an authentication configuration method supported by the first device.

For example, after the third device acquires the information about the first device, to subsequently transfer a message between the first device and the third device, the third device may adjust a working channel of the third device to the working channel of the first device according to the working channel of the first device included in the information about the first device. When it is assumed that the first device is an AP, because a working channel of an AP is fixed, the third device can only adjust the working channel of the third device to the working channel of the first device.

402. The third device shares a third key with the first device using the first key.

In an implementation, reference may be made to a related description in the embodiment shown in FIG. 1 or FIG. 2 or FIG. 3, and details are not described again.

403. The third device sends a first trigger message to the first device.

The first trigger message includes information about the third device, and may further include the third key. To improve security, the third key may be encrypted using the first key.

The information about the third device includes but is not limited to information such as an identifier of the third device and a working channel of the third device.

For example, after the first device receives the information about the third device, to subsequently transfer a message between the first device and the third device, the first device may adjust the working channel of the first device to the working channel of the third device according to the working channel of the third device included in the information about the third device. When it is assumed that the first device is an AP, because the working channel of an AP is fixed, the first device does not need to adjust the working channel of the first device to the working channel of the third device, instead the third device adjusts the working channel of the third device to the working channel of the first device.

404. The third device acquires information about a second device and shares a second key with the second device.

In an implementation, for example, when the second device has a two-dimensional code, the third device acquires, by scanning the two-dimensional code of the second device, the information that is about the second device and corresponding to the two-dimensional code, and negotiates with the second device to generate the second key.

Alternatively, when the second device supports the NFC function, the third device acquires the information about the second device by means of the NFC, and negotiates with the second device to generate the second key.

Alternatively, when the second device supports the short-range WiFi communication function, the third device acquires the information about the second device by means of short-range WiFi communication, and negotiates with the second device to generate the second key.

The information that is about the second device and acquired by the third device includes but is not limited to information such as an identifier of the second device, a working channel of the second device, and an authentication configuration method supported by the second device.

For example, after the third device acquires the information about the second device, to subsequently transfer a message between the second device and the third device, the third device may adjust the working channel of the third device to the working channel of the second device according to the working channel of the second device included in the information about the second device.

When it is assumed that the second device is an AP, because the working channel of an AP is fixed, the third device can only adjust the working channel of the third device to the working channel of the second device.

Step 401 and step 404 are not subject to a specific time sequence.

405. The third device sends a second trigger message to the second device, where the second trigger message includes the information about the first device, information about the third device, and the third key.

To improve security, the third key may be encrypted using the second key.

For example, to subsequently transfer a message between the first device, the second device, and the third device, working channels of the first device, the second device, and the third device need to be adjusted to a same working channel; that is, after receiving the information about the first device and the information about the third device, the second device may adjust the working channel of the second device to the working channel of the first device or the working channel of the third device. It should be noted that, when the second device is an AP, because the working channel of an AP is fixed, the second device needs to send information about the working channel of the second device to the third device and the first device using the information about the second device, such that the first device and the third device adjust their respective working channels to the working channel of the AP according to the information about the working channel of the second device. The information about the second device may be sent to the third device in the foregoing process (that is, using a two-dimensional code or an NFC method or short-range WiFi communication) of performing, by the third device, WPS authentication configuration with the second device, and the third device may send the acquired information about the second device to the first device.

406. The second device establishes, using the third key, a secure connection with the first device according to the information about the first device and the information about the third device.

For establishment of the secure connection, reference may be made to an existing procedure of the WPS authentication configuration or a four-way handshake, and details are not described again.

In this embodiment of the present disclosure, after sharing a first key with a first device, a trusted third device shares a third key with the first device using the first key, and sends the third key to a second device, such that the second device establishes a secure connection between the first device and the second device directly using the third key; therefore, when neither of two wireless devices that are to establish WiFi P2P communication has an input device (such as a keyboard) or a display device (such as a screen), and supported authentication configuration methods are different, the two wireless devices may establish a secure connection for WiFi P2P communication between the two wireless devices based on the authentication of the third device; further, when a wireless device that is to join a WLAN set by an AP does not have an input device or a display device, and supports only a two-dimensional code method, this wireless device may join, based on the authentication of the third device, the WLAN set by the AP. Therefore, a problem that existing WPS authentication configuration has a relatively high requirement on performance of a wireless device may be resolved, and protocol content of the existing WPS authentication configuration is extended.

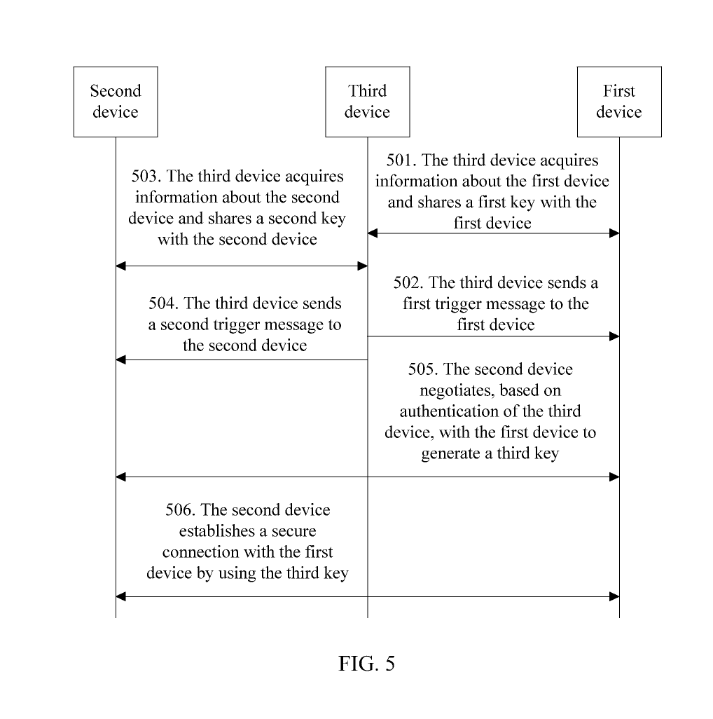

FIG. 5 is a signaling diagram of a method for configuring a wireless device according to another embodiment of the present disclosure. As shown in FIG. 5, the following steps are included.

501. A third device acquires information about a first device and shares a first key with the first device.

In an implementation, reference may be made to a related description of step 401 in the embodiment shown in FIG. 4.

502. The third device sends a first trigger message to the first device.

The first trigger message includes information about the third device.

The information about the third device may include but is not limited to information such as an identifier of the third device and a working channel of the third device.

For example, after the first device receives the information about the third device, to subsequently transfer a message between the first device and the third device, the first device may adjust a working channel of the first device to the working channel of the third device according to the working channel of the third device included in the information about the third device. When it is assumed that the first device is an AP, because a working channel of an AP is fixed, the first device does not need to adjust the working channel of the first device to the working channel of the third device, instead the third device adjusts the working channel of the third device to the working channel of the first device.

503. The third device acquires information about a second device and shares a second key with the second device.

In an implementation, reference may be made to a related description of step 404 in the embodiment shown in FIG. 4.

Step 501 and step 503 are not subject to a specific time sequence.

504. The third device sends a second trigger message to the second device.

The second trigger message includes the information about the first device and the information about the third device.

For example, to subsequently transfer a message between the first device, the second device, and the third device, working channels of the first device, the second device, and the third device need to be adjusted to a same working channel; that is, after receiving the information about the first device and the information about the third device, the second device may adjust the working channel of the second device to the working channel of the first device or the working channel of the third device. It should be noted that, when the second device is an AP, because the working channel of an AP is fixed, the second device needs to send information about the working channel of the second device to the third device and the first device using the information about the second device, such that the first device and the third device adjust their respective working channels to the working channel of the AP according to the information about the working channel of the second device. The information about the second device may be sent to the third device in the foregoing process (that is, using a two-dimensional code or an NFC method or short-range WiFi communication) of performing, by the third device, WPS authentication configuration with the second device, and the third device may send the acquired information about the second device to the first device.

505. The second device negotiates with the first device to generate a third key based on authentication of the third device.

In an implementation, reference may be made to a related description in the embodiment shown in FIG. 1.

Optionally, after the second device acquires the information about the third device and the information about the first device, the second device may send an indication message to the first device, such that the first device initiates an authentication procedure that is based on the third device, and negotiates with the second device to generate the third key.

Authentication based on the third device may, for example, use an Otway-Rees authentication algorithm. Reference may be made to a related description in the embodiment shown in FIG. 1 or FIG. 2, and a specific algorithm is not described again.

506. The second device establishes a secure connection with the first device using the third key.

For establishment of the secure connection, reference may be made to an existing procedure of the WPS authentication configuration or a four-way handshake, and details are not described again.

In this embodiment of the present disclosure, a trusted third-party wireless device (a third device) separately shares a first key with a first device and sends a first trigger message including information about the third device to the first device, and shares a second key with a second device and sends a second trigger message including the information about the third device and information about the first device to the second device, such that the second device negotiates, according to the information about the third device and the information about the first device and based on authentication of the third device, with the first device to generate a third key, and establishes a secure connection between the first device and the second device using the third key; therefore, when neither of two wireless devices that are to establish WiFi P2P communication has an input device (such as a keyboard) or a display device (such as a screen), and supported authentication configuration methods are different, the two wireless devices may establish a secure connection for WiFi P2P communication between the two wireless devices based on the authentication of the third device; further, when a wireless device that is to join a WLAN set by an AP does not have an input device or a display device, and supports only a two-dimensional code method, this wireless device may join, based on the authentication of the third device, the WLAN set by the AP. Therefore, a problem that existing WPS authentication configuration has a relatively high requirement on performance of a wireless device may be resolved, and protocol content of the existing WPS authentication configuration is extended.

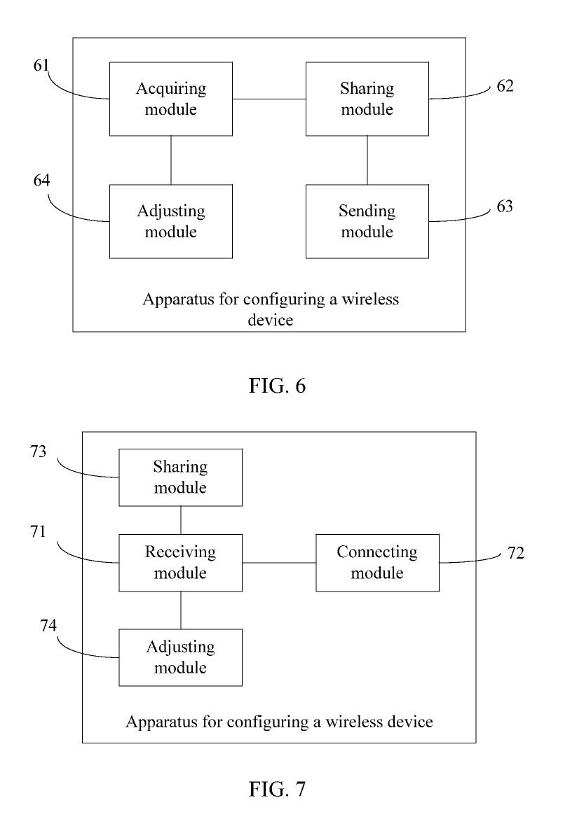

FIG. 6 is a schematic structural diagram of an apparatus for configuring a wireless device according to another embodiment of the present disclosure. The apparatus is located on a side of a third device, and as shown in FIG. 6, the apparatus includes an acquiring module 61 configured to acquire information about a first device; a sharing module 62 configured to share a first key with the first device; and a sending module 63 configured to send a first trigger message to the first device, where the first trigger message includes information about the third device.

The acquiring module 61 is further configured to acquire information about a second device.

The sharing module 62 is further configured to share a second key with the second device.

The sending module 63 is further configured to send a second trigger message to the second device, where the second trigger message includes the information about the third device and the information about the first device, such that the second device negotiates, according to the information about the third device and the information about the first device and based on authentication of the third device, with the first device to generate a third key, and establishes a secure connection between the first device and the second device using the third key.

For example, the acquiring module 61 is configured to acquire, by scanning a two-dimensional code of the first device, the information that is about the first device and corresponding to the two-dimensional code; or acquire the information about the first device by means of NFC; or acquire the information about the first device by means of short-range WiFi communication.

For example, the sharing module 62 is configured to negotiate with the first device to generate the first key; or send the first key to the first device by means of NFC or short-range WiFi communication, or receive the first key sent by the first device; or acquire, by scanning the two-dimensional code of the first device, the first key set by the first device.

For example, the acquiring module 61 is further configured to acquire, by scanning a two-dimensional code of the second device, the information that is about the second device and corresponding to the two-dimensional code; or acquire the information about the second device by means of NFC manner; or acquire the information about the second device by means of short-range WiFi communication.

For example, the sharing module 62 is further configured to negotiate with the second device to generate the second key; or send the second key to the second device by means of NFC or short-range WiFi communication, or receive the second key sent by the second device; or acquire, by scanning the two-dimensional code of the second device, the second key set by the second device.

For example, the sharing module 62 is further configured to share the third key with the first device using the first key.

The first trigger message further includes the third key, and the second trigger message further includes the third key.

The third key included in the first trigger message may be encrypted using the first key.

The third key included in the second trigger message may be encrypted using the second key.

The third key is used by the second device to establish the secure connection between the first device and the second device using the third key.

For example, the third device is a trusted third-party wireless device, has an input device and a display device, and supports at least one of a two-dimensional code identification function, a PIN function, a PBC function, an NFC function, and a short-range WiFi communication function.

For example, the information about the first device includes a working channel of the first device, and the information about the second device includes a working channel of the second device.

The apparatus further includes an adjusting module 64 configured to adjust a working channel of the third device to the working channel of the first device according to the working channel of the first device acquired by the acquiring module 61; or adjust a working channel of the third device to the working channel of the second device according to the working channel of the second device acquired by the acquiring module 61.

In this embodiment of the present disclosure, a trusted third-party wireless device (a third device) separately shares a first key with a first device and sends a first trigger message including information about the third device to the first device, and shares a second key with a second device and sends a second trigger message including the information about the third device and information about the first device to the second device, such that the second device negotiates, according to the information about the third device and the information about the first device and based on authentication of the third device, with the first device to generate a third key, and establishes a secure connection between the first device and the second device using the third key; further, after sharing the first key with the first device, the trusted third device shares the third key with the first device using the first key and sends the third key to the second device, such that the second device establishes the secure connection between the first device and the second device directly using the third key; therefore, when neither of two wireless devices that are to establish WiFi P2P communication has an input device (such as a keyboard) or a display device (such as a screen), and supported authentication configuration methods are different, the two wireless devices may establish a secure connection for WiFi P2P communication between the two wireless devices based on the authentication of the third device; further, when a wireless device that is to join a WLAN set by an AP does not have an input device or a display device, and supports only a two-dimensional code method, this wireless device may join, based on the authentication of the third device, the WLAN set by the AP. Therefore, a problem that existing WPS authentication configuration has a relatively high requirement on performance of a wireless device may be resolved, and protocol content of the existing WPS authentication configuration is extended.

FIG. 7 is a schematic structural diagram of an apparatus for configuring a wireless device according to another embodiment of the present disclosure. The apparatus is located on a side of a second device, and as shown in FIG. 7, the apparatus includes a receiving module 71 configured to receive a second trigger message sent by a third device, where the second trigger message includes information about the third device and information about a first device; and a connecting module 72 configured to negotiate, according to the information about the third device and the information about the first device and based on authentication of the third device, with the first device to generate a third key, and establish a secure connection between the first device and the second device using the third key.

For example, the information about the first device is information that is about the first device, acquired by the third device by scanning a two-dimensional code of the first device, and corresponding to the two-dimensional code; or is information that is about the first device and acquired by the third device by means of NFC; or is information that is about the first device and acquired by the third device by means of short-range WiFi communication.

For example, the apparatus further includes a sharing module 73 configured to send a two-dimensional code of the second device to the third device, and share a second key with the third device, such that the third device acquires information that is about the second device and corresponding to the two-dimensional code; or send information about the second device to the third device by means of NFC, and share a second key with the third device; or send information about the second device to the third device by means of short-range WiFi communication, and share a second key with the third device.

For example, if the second trigger message further includes the third key, where the third key is a third key shared with the first device using a first key after the third device acquires the information about the first device and shares the first key with the first device according to the information about the first device, the connecting module 72 is configured to establish the secure connection between the first device and the second device directly using the third key included in the second trigger message.

For example, the third device is a trusted third-party wireless device, has an input device and a display device, and supports at least one of a two-dimensional code identification function, a PIN function, a PBC function, an NFC function, and a short-range WiFi communication function.

For example, the information about the first device includes a working channel of the first device, and the information about the third device includes a working channel of the third device.

The apparatus further includes an adjusting module 74 configured to adjust a working channel of the second device to the working channel of the first device according to the working channel of the first device received by the receiving module 71; or adjust a working channel of the second device to the working channel of the third device according to the working channel of the third device received by the receiving module 71.

In this embodiment of the present disclosure, a trusted third-party wireless device (a third device) separately shares a first key with a first device and sends a first trigger message including information about the third device to the first device, and shares a second key with a second device and sends a second trigger message including the information about the third device and information about the first device to the second device, such that the second device negotiates, according to the information about the third device and the information about the first device and based on authentication of the third device, with the first device to generate a third key, and establishes a secure connection between the first device and the second device using the third key; further, after sharing the first key with the first device, the trusted third device shares the third key with the first device using the first key and sends the third key to the second device, such that the second device establishes the secure connection between the first device and the second device directly using the third key; therefore, when neither of two wireless devices that are to establish WiFi P2P communication has an input device (such as a keyboard) or a display device (such as a screen), and supported authentication configuration methods are different, the two wireless devices may establish a secure connection for WiFi P2P communication between the two wireless devices based on the authentication of the third device; further, when a wireless device that is to join a WLAN set by an AP does not have an input device or a display device, and supports only a two-dimensional code method, this wireless device may join, based on the authentication of the third device, the WLAN set by the AP. Therefore, a problem that existing WPS authentication configuration has a relatively high requirement on performance of a wireless device may be resolved, and protocol content of the existing WPS authentication configuration is extended.

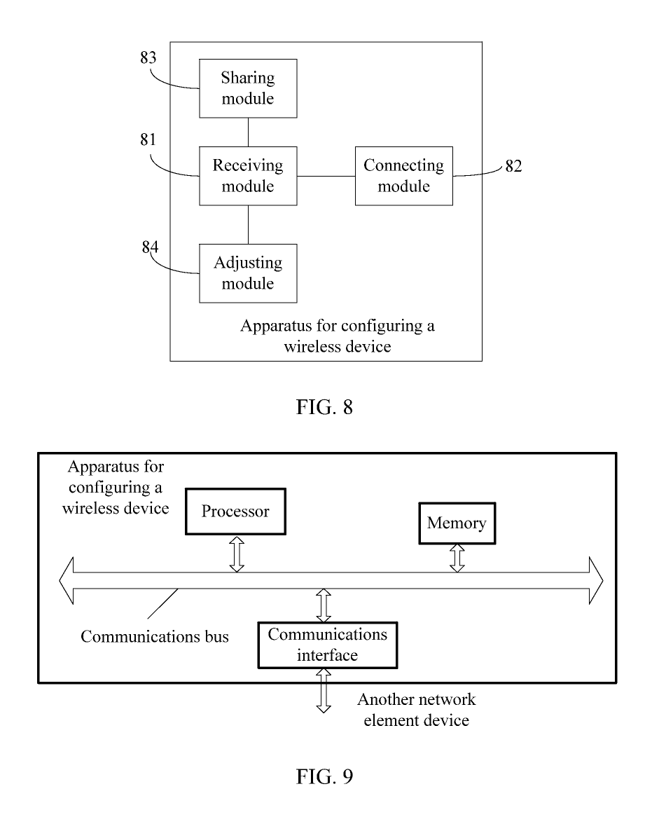

FIG. 8 is a schematic structural diagram of an apparatus for configuring a wireless device according to another embodiment of the present disclosure. The apparatus is located on a side of a first device, and as shown in FIG. 8, the apparatus includes a receiving module 81 configured to receive a first trigger message sent by a third device, where the first trigger message includes information about the third device; and a connecting module 82 configured to negotiate, according to the information about the third device and based on authentication of the third device, with a second device to generate a third key, and establish a secure connection between the first device and the second device using the third key.

For example, the apparatus further includes a sharing module 83 configured to send a two-dimensional code of the first device to the third device, and share the first key with the third device, such that the third device acquires information that is about the first device and corresponding to the two-dimensional code, and sends the information about the first device to the second device; or send information about the first device to the third device by means of NFC, and share the first key with the third device, such that the third device sends the information about the first device to the second device; or send information about the first device to the third device by means of short-range WiFi communication, and share the first key with the third device, such that the third device sends the information about the first device to the second device.

For example, the sharing module 83 is further configured to share the third key with the third device using the first key, such that the third device sends the third key to the second device, and the second device establishes a secure connection with the first device using the third key.

For example, the third device is a trusted third-party wireless device, has an input device and a display device, and supports at least one of a two-dimensional code identification function, a PIN function, a PBC function, an NFC function, and a short-range WiFi communication function.

For example, the information about the third device includes a working channel of the third device.

The apparatus further includes an adjusting module 84 configured to adjust a working channel of the first device to the working channel of the third device according to the working channel of the third device received by the receiving module 81; or adjust a working channel of the first device to a working channel of the second device by receiving information about the second device sent by the second device, where the information about the second device includes the working channel of the second device.

In this embodiment of the present disclosure, a trusted third-party wireless device (a third device) separately shares a first key with a first device and sends a first trigger message including information about the third device to the first device, and shares a second key with a second device and sends a second trigger message including the information about the third device and information about the first device to the second device, such that the second device negotiates, according to the information about the third device and the information about the first device and based on authentication of the third device, with the first device to generate a third key, and establishes a secure connection between the first device and the second device using the third key; further, after sharing the first key with the first device, the trusted third device shares the third key with the first device using the first key and sends the third key to the second device, such that the second device establishes the secure connection between the first device and the second device directly using the third key; therefore, when neither of two wireless devices that are to establish WiFi P2P communication has an input device (such as a keyboard) or a display device (such as a screen), and supported authentication configuration methods are different, the two wireless devices may establish a secure connection for WiFi P2P communication between the two wireless devices based on the authentication of the third device; further, when a wireless device that is to join a WLAN set by an AP does not have an input device or a display device, and supports only a two-dimensional code method, this wireless device may join, based on the authentication of the third device, the WLAN set by the AP. Therefore, a problem that existing WPS authentication configuration has a relatively high requirement on performance of a wireless device may be resolved, and protocol content of the existing WPS authentication configuration is extended.

FIG. 9 is a schematic structural diagram of an apparatus for configuring a wireless device according to another embodiment of the present disclosure. The apparatus is located on a side of a third device, and as shown in FIG. 9, the apparatus includes a processor, a memory, and a communications bus, where the memory stores an instruction that implements a method for configuring a wireless device, and the processor is connected to the memory by the communications bus. Further, the apparatus further includes a communications interface and establishes a communications connection with another network element device (such as a first device and a second device) using the communications interface.

When the processor invokes the instruction stored in the memory, the following steps may be executed: acquiring information about the first device, sharing a first key with the first device, and sending a first trigger message to the first device, where the first trigger message includes information about the third device; and acquiring information about the second device, sharing a second key with the second device, and sending a second trigger message to the second device, where the second trigger message includes the information about the third device and the information about the first device, such that the second device negotiates, according to the information about the third device and the information about the first device and based on authentication of the third device, with the first device to generate a third key, and establishes a secure connection between the first device and the second device using the third key.

For example, the acquiring information about the first device includes acquiring, by scanning a two-dimensional code of the first device, the information that is about the first device and corresponding to the two-dimensional code; or acquiring the information about the first device by means of NFC; or acquiring the information about the first device by means of short-range WiFi communication.

For example, the sharing a first key with the first device includes negotiating with the first device to generate the first key; or sending the first key to the first device by means of NFC or short-range WiFi communication, or receiving the first key sent by the first device; or acquiring, by scanning the two-dimensional code of the first device, the first key set by the first device.

For example, the acquiring information about the second device includes acquiring, by scanning a two-dimensional code of the second device, the information that is about the second device and corresponding to the two-dimensional code; or acquiring the information about the second device by means of NFC manner; or acquiring the information about the second device by means of short-range WiFi communication.

For example, the sharing a second key with the second device includes negotiating with the second device to generate the second key; or sending the second key to the second device by means of NFC or short-range WiFi communication, or receive the second key sent by the second device; or acquiring, by scanning the two-dimensional code of the second device, the second key set by the second device.

For example, after the acquiring information about the first device and sharing a first key with the first device, the following is included: sharing the third key with the first device using the first key.

The first trigger message further includes the third key, and the second trigger message further includes the third key.

The third key included in the first trigger message may be encrypted using the first key.

The third key included in the second trigger message may be encrypted using the second key.

The third key is used by the second device to establish the secure connection between the first device and the second device using the third key.

For example, the third device is a trusted third-party wireless device, has an input device and a display device, and supports at least one of a two-dimensional code identification function, a PIN function, a PBC function, an NFC function, and a short-range WiFi communication function.

For example, the information about the first device includes a working channel of the first device, and the information about the second device includes a working channel of the second device.

After the acquiring information about the first device or after acquiring information about the second device, the following is included: adjusting a working channel of the third device to the working channel of the first device according to the working channel of the first device; or adjusting a working channel of the third device to the working channel of the second device according to the working channel of the second device.

In this embodiment of the present disclosure, a trusted third-party wireless device (a third device) separately shares a first key with a first device and sends a first trigger message including information about the third device to the first device, and shares a second key with a second device and sends a second trigger message including the information about the third device and information about the first device to the second device, such that the second device negotiates, according to the information about the third device and the information about the first device and based on authentication of the third device, with the first device to generate a third key, and establishes a secure connection between the first device and the second device using the third key; further, after sharing the first key with the first device, the trusted third device shares the third key with the first device using the first key and sends the third key to the second device, such that the second device establishes the secure connection between the first device and the second device directly using the third key; therefore, when neither of two wireless devices that are to establish WiFi P2P communication has an input device (such as a keyboard) or a display device (such as a screen), and supported authentication configuration methods are different, the two wireless devices may establish a secure connection for WiFi P2P communication between the two wireless devices based on the authentication of the third device; further, when a wireless device that is to join a WLAN set by an AP does not have an input device or a display device, and supports only a two-dimensional code method, this wireless device may join, based on the authentication of the third device, the WLAN set by the AP. Therefore, a problem that existing WPS authentication configuration has a relatively high requirement on performance of a wireless device may be resolved, and protocol content of the existing WPS authentication configuration is extended.

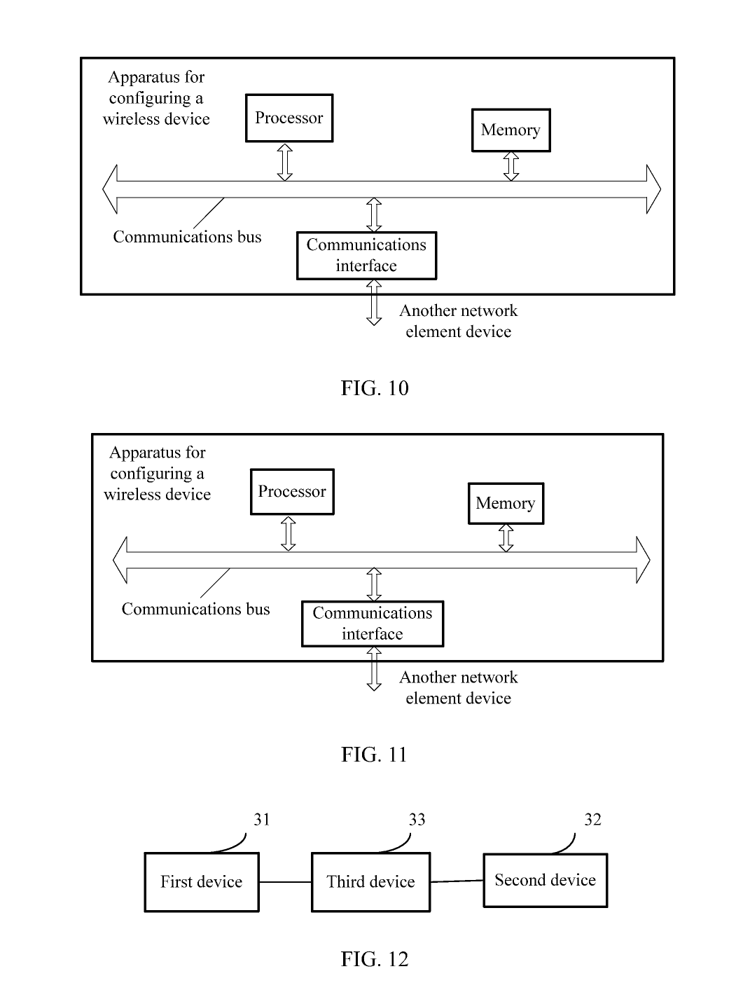

FIG. 10 is a schematic structural diagram of an apparatus for configuring a wireless device according to another embodiment of the present disclosure. The apparatus is located on a side of a second device, and as shown in FIG. 10, the apparatus includes a processor, a memory, and a communications bus, where the memory stores an instruction that implements a method for configuring a wireless device, and the processor is connected to the memory by the communications bus. Further, the apparatus further includes a communications interface and establishes a communication connection with another network element device (such as a first device and a third device) using the communications interface.

When the processor invokes the instruction stored in the memory, the following steps may be executed: receiving a second trigger message sent by the third device, where the second trigger message includes information about the third device and information about the first device; and negotiating, according to the information about the third device and the information about the first device and based on authentication of the third device, with the first device to generate a third key, and establishing a secure connection between the first device and the second device using the third key.

For example, the information about the first device is information that is about the first device, acquired by the third device by scanning a two-dimensional code of the first device, and corresponding to the two-dimensional code; or is information that is about the first device and acquired by the third device by means of NFC; or is information that is about the first device and acquired by the third device by means of short-range WiFi communication.

For example, before the receiving a second trigger message sent by the third device, the following is included: sending a two-dimensional code of the second device to the third device, and sharing a second key with the third device, such that the third device acquires information that is about the second device and corresponding to the two-dimensional code; or sending information about the second device to the third device by means of NFC, and sharing a second key with the third device; or sending information about the second device to the third device by means of short-range WiFi communication, and sharing a second key with the third device.

For example, if the second trigger message further includes the third key, where the third key is a third key shared with the first device using a first key after the third device acquires the information about the first device and shares the first key with the first device according to the information about the first device, after the receiving a second trigger message sent by a third device, the following is included: establishing a secure connection between the first device and the second device using the third key.

For example, the third device is a trusted third-party wireless device, has an input device and a display device, and supports at least one of a two-dimensional code identification function, a PIN function, a PBC function, an NFC function, and a short-range WiFi communication function.

For example, the information about the first device includes a working channel of the first device, and the information about the third device includes a working channel of the third device, and the following is included: adjusting a working channel of the second device to the working channel of the first device according to the working channel of the first device; or adjusting a working channel of the second device to the working channel of the third device according to the working channel of the third device.

In this embodiment of the present disclosure, a trusted third-party wireless device (a third device) separately shares a first key with a first device and sends a first trigger message including information about the third device to the first device, and shares a second key with a second device and sends a second trigger message including the information about the third device and information about the first device to the second device, such that the second device negotiates, according to the information about the third device and the information about the first device and based on authentication of the third device, with the first device to generate a third key, and establishes a secure connection between the first device and the second device using the third key; further, after sharing the first key with the first device, the trusted third device shares the third key with the first device using the first key and sends the third key to the second device, such that the second device establishes the secure connection between the first device and the second device directly using the third key; therefore, when neither of two wireless devices that are to establish WiFi P2P communication has an input device (such as a keyboard) or a display device (such as a screen), and supported authentication configuration methods are different, the two wireless devices may establish a secure connection for WiFi P2P communication between the two wireless devices based on the authentication of the third device; further, when a wireless device that is to join a WLAN set by an AP does not have an input device or a display device, and supports only a two-dimensional code method, this wireless device may join, based on the authentication of the third device, the WLAN set by the AP. Therefore, a problem that existing WPS authentication configuration has a relatively high requirement on performance of a wireless device may be resolved, and protocol content of the existing WPS authentication configuration is extended.

FIG. 11 is a schematic structural diagram of an apparatus for configuring a wireless device according to another embodiment of the present disclosure. The apparatus is located on a side of a first device, and as shown in FIG. 11, the apparatus includes a processor, a memory, and a communications bus, where the memory stores an instruction that implements a method for configuring a wireless device, and the processor is connected to the memory by the communications bus. Further, the apparatus further includes a communications interface and establishes a communication connection with another network element device (such as a third device and a second device) using the communications interface.

When the processor invokes the instruction stored in the memory, the following steps may be executed: receiving a first trigger message sent by the third device, where the first trigger message includes information about the third device; and negotiating, according to the information about the third device and based on authentication of the third device, with the second device to generate a third key, and establishing a secure connection between the first device and the second device using the third key.

For example, before the receiving a first trigger message sent by the third device, the following is included: sending a two-dimensional code of the first device to the third device, and sharing a first key with the third device, such that the third device acquires information that is about the first device and corresponding to the two-dimensional device, and sends the information about the first device to the second device; or sending information about the first device to the third device by means of NFC, and sharing a first key with the third device, such that the third device sends the information about the first device to the second device; or sending information about the first device to the third device by means of short-range WiFi communication, and sharing a first key with the third device, such that the third device sends the information about the first device to the second device.

For example, after the sending the information about the first device to the third device, and sharing a first key with the third device, the following is included: sharing the third key with the third device using the first key, such that the third device sends the third key to the second device, and the second device establishes a secure connection with the first device using the third key.

For example, the third device is a trusted third-party wireless device, has an input device and a display device, and supports at least one of a two-dimensional code identification function, a PIN function, a PBC function, an NFC function, and a short-range WiFi communication function.

For example, the information about the third device includes a working channel of the third device.

After the receiving a first trigger message sent by the third device, the following is included: adjusting a working channel of the first device to the working channel of the third device according to the working channel of the third device; or receiving information about the second device sent by the second device, where the information about the second device includes a working channel of the second device, and adjusting a working channel of the first device to the working channel of the second device.

In this embodiment of the present disclosure, a trusted third-party wireless device (a third device) separately shares a first key with a first device and sends a first trigger message including information about the third device to the first device, and shares a second key with a second device and sends a second trigger message including the information about the third device and information about the first device to the second device, such that the second device negotiates, according to the information about the third device and the information about the first device and based on authentication of the third device, with the first device to generate a third key, and establishes a secure connection between the first device and the second device using the third key; further, after sharing the first key with the first device, the trusted third device shares the third key with the first device using the first key and sends the third key to the second device, such that the second device establishes the secure connection between the first device and the second device directly using the third key; therefore, when neither of two wireless devices that are to establish WiFi P2P communication has an input device (such as a keyboard) or a display device (such as a screen), and supported authentication configuration methods are different, the two wireless devices may establish a secure connection for WiFi P2P communication between the two wireless devices based on the authentication of the third device; further, when a wireless device that is to join a WLAN set by an AP does not have an input device or a display device, and supports only a two-dimensional code method, this wireless device may join, based on the authentication of the third device, the WLAN set by the AP. Therefore, a problem that existing WPS authentication configuration has a relatively high requirement on performance of a wireless device may be resolved, and protocol content of the existing WPS authentication configuration is extended.

FIG. 12 is a schematic structural diagram of a system for configuring a wireless device according to another embodiment of the present disclosure. As shown in FIG. 12, the system includes a first device 31, a second device 32, and a third device 33.

The first device 31 includes the apparatus for configuring a wireless device in the embodiment shown in FIG. 8 or FIG. 11; the second device 32 includes the apparatus for configuring a wireless device in the embodiment shown in FIG. 7 or FIG. 10; and the third device 33 includes the apparatus for configuring a wireless device in the embodiment shown in FIG. 6 or FIG. 9.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) to perform some of the steps of the methods described in the embodiments of the present disclosure. The foregoing storage medium includes any medium that can store program code, such as a universal serial bus (USB) flash drive, a removable hard disk, a read-only memory (ROM), a random access memory (RAM), a magnetic disk, or an optical disc.

Finally, it should be noted that the foregoing embodiments are merely intended for describing the technical solutions of the present disclosure other than limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

What is claimed is:

1. A method for configuring a wireless device, comprising:
acquiring, by a third device, information about a first device;
sharing a first key with the first device;
sending a first trigger message to the first device, wherein the first trigger message comprises information about the third device;
acquiring, by the third device, information about a second device;
sharing a second key with the second device;
sending a second trigger message to the second device, wherein the second trigger message comprises the information about the third device and the information about the first device so that the second device:
negotiates, according to the information about the third device and the information about the first device and based on authentication of the third device, with the first device to generate a third key; and
establishes a connection with the first device using the third key.

2. The method according to claim 1, wherein acquiring, by the third device, the information about the first device comprises at least one of:
acquiring, by the third device and by scanning a two-dimensional code of the first device, the information about the first device corresponding to the two-dimensional code of the first device;
acquiring, by the third device, the information about the first device in a near field communication (NFC) manner; and
acquiring, by the third device, the information about the first device in a short-range WiFi communication manner.

3. The method according to claim 1, wherein acquiring, by the third device, the information about the second device comprises at least one of:
acquiring, by the third device and by scanning a two-dimensional code of the second device, the information about the second device corresponding to the two-dimensional code of the second device;
acquiring, by the third device, the information about the second device in an NFC) manner; and
acquiring, by the third device, the information about the second device in a short-range WiFi communication manner.

4. The method according to claim 2, wherein sharing the first key with the first device comprises at least one of:
negotiating, by the third device, with the first device to generate the first key;
sending, by the third device, the first key to the first device in at least one of the NFC manner and the short-range WiFi communication manner;
receiving, by the third device, the first key sent by the first device in at least one of the NFC manner and the short-range WiFi communication manner; and
acquiring, by the third device and by scanning the two-dimensional code of the first device, the first key set by the first device.

5. The method according to claim 3, wherein sharing the second key with the second device comprises at least one of:
negotiating, by the third device, with the second device to generate the first key;
sending, by the third device, the second key to the second device in at least one of the NFC manner and the short-range WiFi communication manner;
receiving, by the third device, the second key sent by the second device; and
acquiring, by the third device and by scanning the two-dimensional code of the second device, the second key set by the second device.

6. The method according to claim 2, wherein the information about the first device comprises a working channel of the first device, and wherein, after acquiring, by the third device, the information about the first device, the method comprises adjusting, by the third device, a working channel of the third device to the working channel of the first device according to the working channel of the first device.

7. The method according to claim 3, wherein the information about the second device comprises a working channel of the second device, and wherein, after acquiring, by the third device, the information about the second device, the method comprises adjusting, by the third device, a working channel of the third device to the working channel of the second device according to the working channel of the second device.

8. A method for configuring a wireless device, comprising:
receiving, by a second device, a second trigger message sent by a third device, wherein the second trigger message comprises information about the third device and information about a first device, and wherein the second trigger message is sent to the second device after the third device acquires information about the second device and shares a second key with the second device; and
negotiating, by the second device according to the information about the third device and the information about the first device and based on authentication of the third device, with the first device to generate a third key; and
establishing a connection with the first device using the third key.

9. The method according to claim 8, wherein the information about the first device is at least one of the:
information that is about the first device, acquired by the third device by scanning a two-dimensional code of the first device, and corresponding to the two-dimensional code;
information that is about the first device and acquired by the third device by means of near field communication (NFC); and
information that is about the first device and acquired by the third device by means of short-range WiFi communication.

10. The method according to claim 8, wherein before receiving, by the second device, the second trigger message sent by the third device, the method comprises:
sending, by the second device, a two-dimensional code of the second device to the third device; and
sharing the second key with the third device, such that the third device acquires the information that is about the second device and corresponding to the two-dimensional code.

11. The method according to claim 8, wherein before receiving, by the second device, the second trigger message sent by the third device, the method comprises:
sending the information about the second device to the third device by means of NFC; and
sharing the second key with the third device.

12. The method according to claim 8, wherein before receiving, by the second device, the second trigger message sent by the third device, the method comprises:
sending the information about the second device to the third device by means of short-range WiFi communication; and
sharing the second key with the third device.

13. The method according to claim 8, wherein the information about the first device comprises a working channel of the first device, wherein the information about the third device comprises a working channel of the third device, and wherein, after receiving, by the second device, the second trigger message sent by the third device, the method comprises at least one of:
adjusting, by the second device, a working channel of the second device to the working channel of the first device according to the working channel of the first device; and
adjusting, by the second device, a working channel of the second device to the working channel of the third device according to the working channel of the third device.

14. A wireless device comprising:
a memory; and
a processor coupled with the memory, wherein the processor is configured to:
acquire information about a first device;
share a first key with the first device;
send a first trigger message to the first device, wherein the first trigger message comprises information about the wireless device;
acquire information about a second device;
share a second key with the second device;
send a second trigger message to the second device, wherein the second trigger message comprises the information about the wireless device and the information about the first device so that the second device:
negotiates, according to the information about the wireless device and the information about the first device and based on authentication of the wireless device, with the first device to generate a third key; and
establishes a connection with the first device using the third key.

15. The wireless device according to claim 14, wherein the processor is configured to at least one of:
acquire the information about the first device corresponding to a two-dimensional code by the wireless device scanning the two-dimensional code;
acquire the information about the first device in a near field communication (NFC) manner; and
acquire the information about the first device in a short-range WiFi communication manner.

16. The wireless device according to claim 14, wherein the processor is configured to at least one of:
acquire the information about the second device corresponding to a two-dimensional code by the wireless device scanning the two-dimensional code;
acquire the information about the second device in an NFC manner; and
acquire the information about the second device in a short-range WiFi communication manner.

17. The wireless device according to claim 14, wherein the processor is configured to share the first key with the first device by being configured to at least one of:
negotiate with the first device to generate the first key;
send the first key to the first device in at least one of an NFC) manner and a short-range WiFi communication manner;
receive the first key sent by the first device in at least one of the NFC manner and the short-range WiFi communication manner; and
acquire the first key set by the first device by the wireless device scanning a two-dimensional code of the first device.

18. The wireless device according to claim 14, wherein the processor is configured to share the second key with the second device by being configured to at least one of:
negotiate with the second device to generate the second key;
send the second key to the second device in at least one of an NFC) manner and a short-range WiFi communication manner;
receive the second key sent by the second device in at least one of the NFC manner and the short-range WiFi communication manner; and
acquire the second key set by the second device by the wireless device scanning a two-dimensional code of the second device.

19. The wireless device according to claim 14, wherein the information about the first device comprises a working channel of the first device, and wherein the processor is configured to adjust a working channel of the wireless device to the working channel of the first device according to the working channel of the first device after the information about the first device is acquired.

20. The wireless device according to claim 14, wherein the information about the second device comprises a working channel of the second device, and wherein the processor is configured to adjust a working channel of the wireless device to the working channel of the second device according to the working channel of the second device after the information about the second device is acquired.

21. A device served as a second device comprising:
a memory; and
a processor coupled with the memory, wherein the processor is configured to:
receive a second trigger message sent by a third device, wherein the second trigger message comprises information about the third device and information about a first device and wherein the second trigger message is sent to the second device after the third device acquires information about the second device and shares a second key with the second device; and
negotiate, according to the information about the third device and the information about the first device and based on authentication of the third device, with the first device to generate a third key, and
establish a connection with the first device using the third key.

22. The device according to claim 21, wherein the information about the first device is at least one of:
information that is about the first device, acquired by the third device by scanning a two-dimensional code of the first device, and corresponding to the two-dimensional code;
information that is about the first device and acquired by the third device by means of NFC; and
information that is about the first device and acquired by the third device by means of short-range WiFi communication.

23. The device according to claim 21, wherein the processor is configured to:
send a two-dimensional code of the second device to the third device; and
share the second key with the third device before the second trigger message sent by the third device is received, such that the third device acquires the information that is about the second device and corresponding to the two-dimensional code.

24. The device according to claim 21, wherein the processor is configured to:
send the information about the second device to the third device by means of NFC; and
share the second key with the third device before the second trigger message sent by the third device is received.

25. The device according to claim 21, wherein the processor is configured to:
send the information about the second device to the third device by means of short-range WiFi communication; and
share the second key with the third device before the second trigger message sent by the third device is received.

26. The device according to claim 21, wherein the information about the first device comprises a working channel of the first device, wherein the information about the third device comprises a working channel of the third device, and wherein the processor is configured to at least one of:
adjust a working channel of the second device to the working channel of the first device according to the working channel of the first device after the second trigger message sent by a third device is received; and
adjust a working channel of the second device to the working channel of the third device according to the working channel of the third device after the second trigger message sent by a third device is received.
